(19) United States
(12) Patent Application Publication
(10) Pub. No.: US 2010/0050376 A1
(43) Pub. Date: Mar. 4, 2010

(54) Luggage Wheel

(76) Inventor: Hung Kwan Tsang, Kwai Chung (HK)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 12/550,022

(22) Filed: Aug. 28, 2009

(30) Foreign Application Priority Data
Aug. 28, 2008 (GB) 0815649.9

(51) Int. Cl. B60B 33/00

(52) U.S. Cl. 16/45

(57) ABSTRACT

A luggage wheel assembly that typically includes a wheel body that has an axial bearing, an axle connected to the axial bearing and engaged to a wheel housing in use so that the wheel body has an outer side facing away from the wheel housing, a fixing plate secured to the outer side of the wheel body, a cover plate removeably secured to the fixing plate and extending from a central portion of the outer side of the wheel towards a rim of the wheel body.

### CROSS REFERENCE TO RELATED APPLICATION

This application claims priority to United Kingdom Application Serial Number 0815649.9, filed on Aug. 28, 2008, the disclosure of which is hereby incorporated by reference in its entirety.

### TECHNICAL FIELD

This invention relates to a wheel assembly for a suitcase, briefcase, backpack or other article of luggage of the kind which has wheels to enable the luggage to be drawn along the ground.

### BACKGROUND OF THE INVENTION

Wheeled luggage is commonly used for airline or other travel purposes. Such luggage is particularly prone to damage during baggage handling at airports or when the luggage is being drawn through the streets or down stairs. Since the wheels protrude from the luggage they are easily damaged by collisions with the ground or other objects during baggage handling or other use. Many luggage items are fashion accessories so that a smart unblemished appearance is desirable. Accordingly there is a need to reduce the risk of damage to wheels of such baggage in order to avoid the need for replacement.

A conventional luggage wheel comprises an axle mounted on a bearing and carrying a wheel with a rim made of hardwearing toughened plastics material.

GB-A-2291042 discloses a luggage wheel assembly in which a wheel mounted on a shaft has a cover plate secured to the wheel by means of circumferential clips.

These and other features, advantages, and objects of the present invention will be further understood and appreciated by those skilled in the art by reference to the following specification, claims, and appended drawings.

### BRIEF SUMMARY OF THE INVENTION

According to the present invention a luggage wheel assembly comprises a wheel body having an axial bearing, an axle connected to the bearing, the axle being engageable to a wheel housing in use so that the wheel has an outer side facing away from the housing, a fixing plate secured to the outer side of the wheel, a cover plate removably secured to the fixing plate, the cover plate extending from a central portion of the outer side of the wheel towards a rim of the wheel.

In a preferred embodiment the fixing plate is circular and located axially of the wheel, secured to the wheel by a plurality of fixings (fasteners), for example screws. Three equiangularly located screws or bolts may be employed conveniently.

In a preferred embodiment the cover plate is circular and secured by an axial fixing, for example, a bolt or screw, engaged with an axial threaded bore in the fixing plate.

In a preferred embodiment the cover plate has a convex domed cross sectional shape. Alternatively, the cover plate may be conical, planar or otherwise shaped.

The use of an axially secured removable cover plate confers several advantages. The cover plate can be replaced without the need for replacing the entire wheel assembly. The cover plate may also be removed for cleaning, particularly for removal of dirt located within the wheel assembly. Access to the bearing for lubrication is also facilitated.

In addition the cover plate can be customised so that the luggage has a similar design to other articles with which it may be used. For example the cover plate may be selected to resemble a car hub cap so that the appearance of the luggage is co-ordinated with the wheel trim of a sports car or other luxury car.

The fixing plates may be metallic to provide rigidity to the wheel assembly, allowing use of less polymeric material. In addition the fixing plate provides resilience to the assembly and provides a protective cover over the underlying wheel bearing and axle. In addition the fixing plate may be configured to have the appearance of a sports or luxury car disc brake, enhancing the aesthetic appeal and stylistic co-ordination with a user's car.

The cover may be made of flexible or resilient energy absorbing material to minimize the effect of an impact on the wheel assembly. Use of metal or resilient plastics material is preferred. Use of a single axial fixing allows the outer portion of the cover plate to be flexible during impact, providing resilient protection and preventing damage such as might occur if the plate is more rigidly fixed, for example, by circumferential clips. In addition, the cover may be constructed of impact and scratch resistant material so that a tidy appearance is maintained after a period of use.

The circumference of the cover plate may include a plurality of inwardly facing projections adapted to be recessed in correspondingly configured radially extending rebates, channels or apertures provided in the rim of the wheel. Positive engagement between the projections and apertures allows the rim of the plate to be slidably supported in order to absorb impacts during use. As external pressure is applied to the cover plate the domed structure may be flattened, causing the projections to slide outwardly within the rebates, channels or apertures, preventing damage to the cover.

The projections may extend axially from the rim of the cover plate. The projections may comprise rounded lugs, for example having domed ends to minimise friction with the rim of the wheel.

The rim of the wheel may include channels dimiensioned to receive respective lugs. The channels are preferably arranged to extend axially of the wheel and are inclined from a radially inner portion to a radially outer portion, the radially inner portion being disposed axially inwardly of the wheel and the radially outer portion being disposed axially outwardly of the wheel. In this arrangement, increasing external pressure on the cover, urging the cover axially inwardly, causes radially outward movement of the rim of the cover as the convex body of the cover is flattened. The inclined channels maintain supporting contact with the lugs and hence with the cover as the latter is progressively flattened by application of increasing force.

In order to facilitate flattening of the cover, the cover may comprise a hub, a rim and radially extending arms defining radially extending apertures between the arms. Preferably the thickness of the arms decreases from the hub towards the rim. This increases the flexibility of the outer parts of the arms, preventing an increase in stiffness of the outer part of the cover in use. The use of arms which are thinner in the outward portions decreases the weight and inertia of the rim of the cover. The apertures preferably increase in size outwardly of the cover and may be generally wedge-shaped or trapezoidal. Ejection of dirt or debris as the wheel is rotated in use is facilitated by this provision of apertures having a greater width at the rim.

### BRIEF DESCRIPTION OF THE DRAWINGS

FIGS. 1 to 6 illustrate successive stages of assembly of a wheel assembly in accordance with an embodiment of the present invention;

FIG. 7 is an exploded perspective view of the assembly; and

FIGS. 8 and 8a are a side elevation of the exploded view shown in FIG. 7.

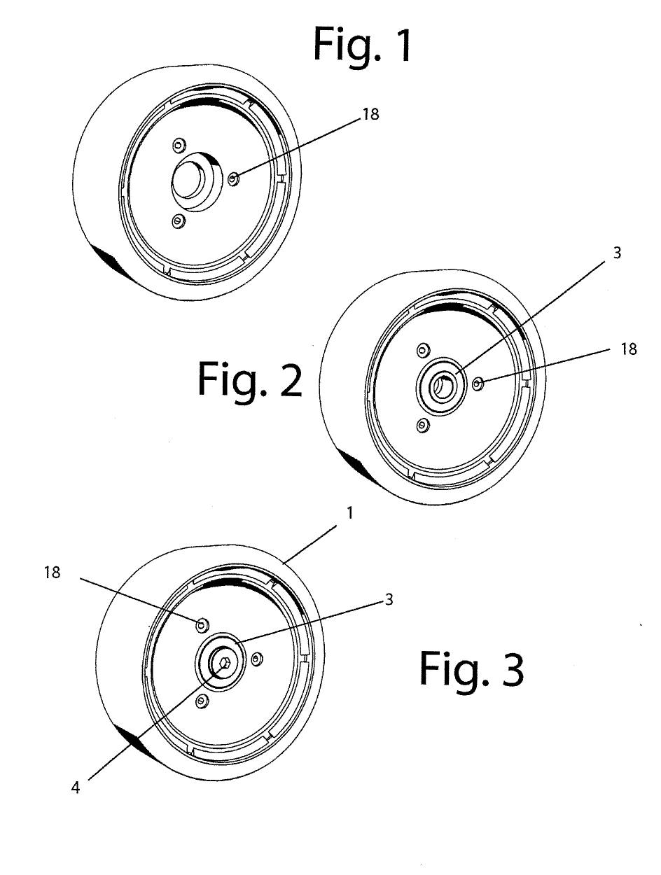

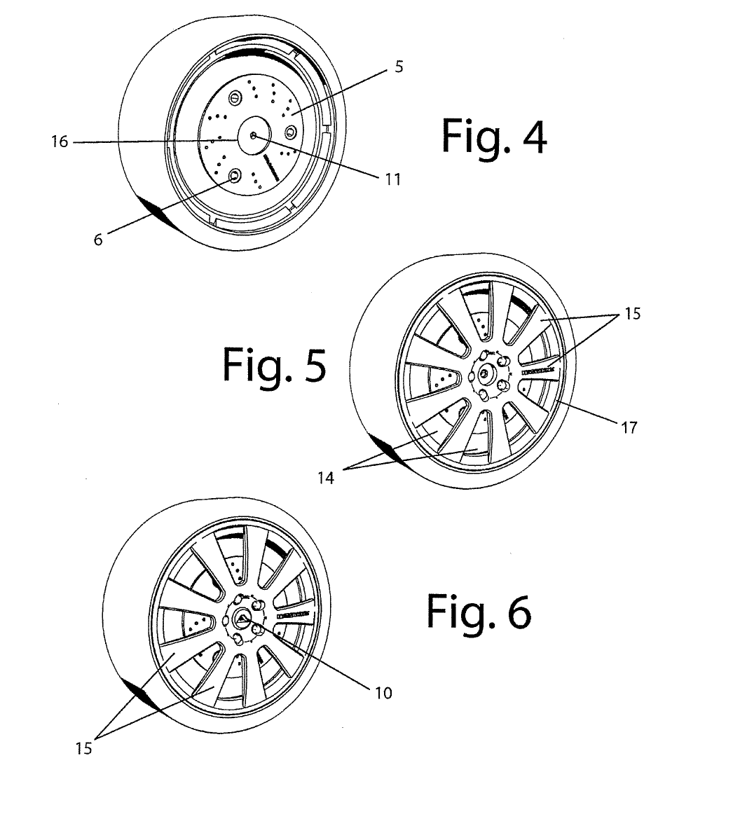

### DETAILED DESCRIPTION

The assembly shown in the Figures comprises a wheel body 1 composed of hard wearing polymeric material, an axle 2 extending through a bearing 3 in the wheel and connected to the wheel housing 20 of a luggage unit. The axle 2 has a head 4 including a hexagonal socket to facilitate engagement by screwing into the wheel housing 20 through the axial bearing 3 of the wheel body 1. Three equiangularly spaced threaded bores 18 in the outer face of the wheel body 1 are arranged to co-operate with bolts 8 passing through pillar members 7 extending rearwardly from a corresponding number of bores 6 on a circular fixing plate 5. The tubular pillar members 7 engage within the openings of the bores 18 to securely engage the fixing plate in use. The fixing plate 5 serves to cover the bearing 3 and axle 2 preventing ingress of dirt during use. The axle may be secured to the housing so that it does not rotate in use, with the bearing and wheel being free running on the axle.

In an alternative embodiment, the axle 2 may be then allowed to rotate but is retained in position by contact with the rear surface of the plate 5, the head 4 being free running but being prevented from excessive axial movement by contact between the bearing 3 and the rear surface of the plate 5. The fixing plate 5 may have arrays of apertures so as to present the appearance of a vehicle disc brake.

A cylindrical rebate 16 and threaded bore 11 serve to receive the cover plate 9 and fixing bolt 10 respectively, providing a positive engagement between the cover plate 9 and wheel body 1.

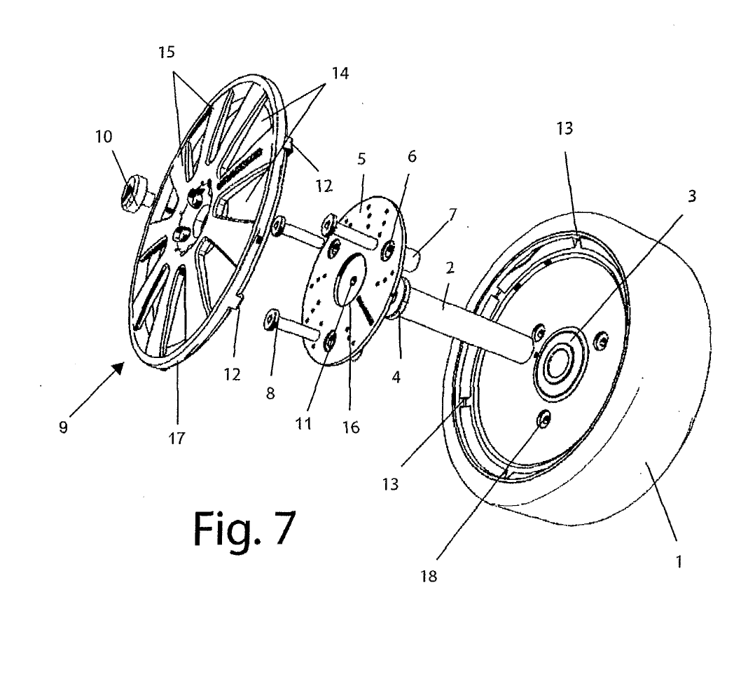

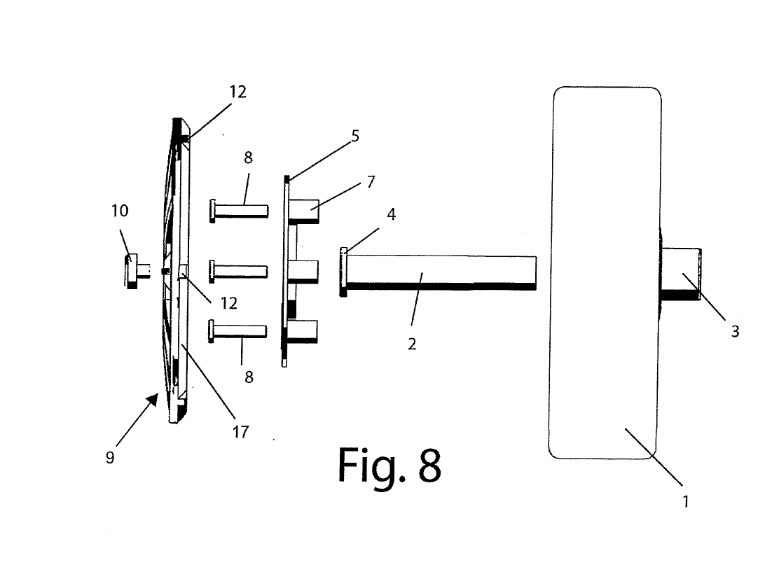

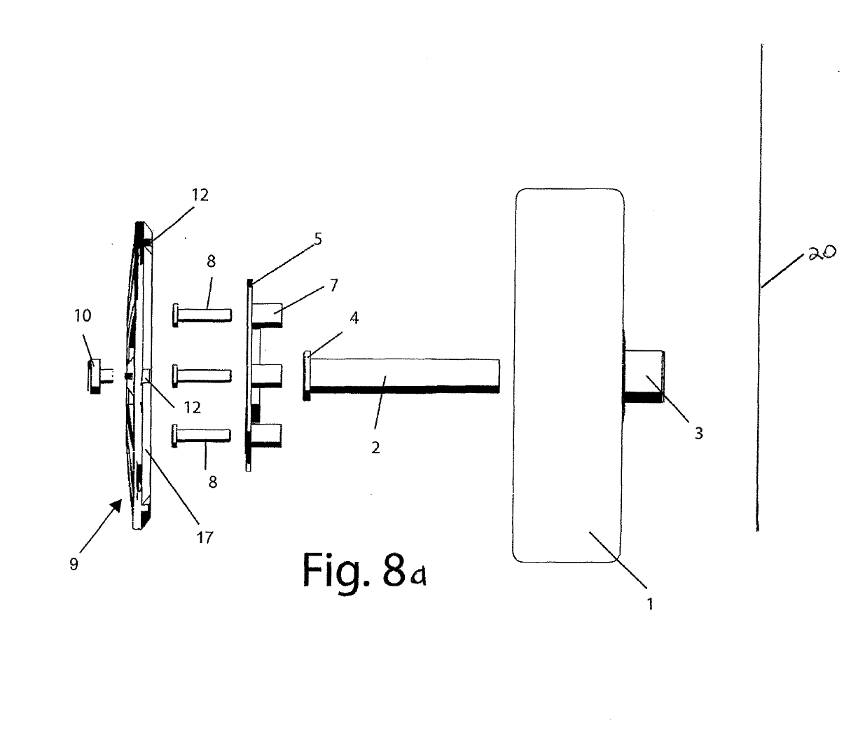

The cover plate, 9 formed of resilient scratch resistant material such as metal or engineering plastics, is dome shaped in cross section and comprises a rim and multiplicity of radial arms 15 defining radial apertures 14 between the arms. A multiplicity of rearwardly extending projections or lugs 12 extend from the rim 9 and are engaged in correspondingly shaped slots 13 in the rim of the wheel body 1 as shown in FIG. 7.

The projections or lugs 12 extend axially from the rim of the cover plate. The projections may have domed ends to minimise friction with the rim of the wheel.

The slots 13 in the rim of the wheel body 1 comprise channels dimensioned to receive respective lugs. The channels are inclined from a radially inner portion to a radially outer portion, the radially inner portion being disposed axially inwardly of the wheel and the radially outwardly portion of the wheel being disposed axially outwardly of the wheel. This arrangement maintains the channels in supporting contact with the lugs upon application of increasing external pressure on the cover.

The radial arms 15 decrease in thickness from the hub to the rim, increasing flexibility of the outer part of the cover and preventing an unwanted increase in stiffness of the outer part of the cover, which stiffness might hinder resilient deformation of the cover in use.

In an alternative embodiment, the wheel is provided with lugs or projections which co-operate with slots or apertures in the circumference of the cover plate.

During assembly the cover plate 9 is placed within the cavity defined by the rim of the wheel with the projections 12 engaging in the slots 13. The fixing bolt 10 is inserted through the central aperture and received into the axial bore 11 of the fixing plate.

The cover plate 9 may be readily removed by undoing the bolt 10 for replacement with a fresh cover plate as desired in order to maintain a smart appearance to the luggage wheel.

The above description is considered that of the preferred embodiments only. Modifications of the invention will occur to those skilled in the art and to those who make or use the invention. Therefore, it is understood that the embodiments shown in the drawings and described above are merely for illustrative purposes and not intended to limit the scope of the invention, which is defined by the following claims as interpreted according to the principles of patent law, including the doctrine of equivalents.

What is claimed is:

1. A luggage wheel assembly comprising a wheel body having:
an axial bearing;
an axle connected to the axial bearing, the axle engaged to a wheel housing in use so that the wheel body has an outer side facing away from the wheel housing;
a fixing plate secured to the outer side of the wheel body; and
a cover plate removably secured to the fixing plate wherein the cover plate extends from a central portion of the outer side of the wheel body towards a rim of the wheel body.

2. The luggage wheel assembly of claim 1, wherein a circular fixing plate is secured axially to the outer side of the wheel by a plurality of equiangularly spaced fixings.

3. The luggage wheel assembly of claim 1, wherein the cover plate is circular and secured by an axial fixing to the fixing plate.

4. The luggage wheel assembly of claim 2, wherein the fixings comprise screws or bolts.

5. The luggage wheel assembly of claim 1, wherein the cover plate is composed of a resilient material.

6. The luggage wheel assembly of claim 1, wherein the circumference of the cover plate includes a plurality of inwardly facing projections adapted to cooperate with complementarily shaped formations of the rim of the wheel.

7. The luggage wheel assembly of claim 2, wherein the circumference of the cover plate includes a plurality of inwardly facing projections adapted to cooperate with complementarily shaped formations of the rim of the wheel.

8. The luggage wheel assembly of claim 3, wherein the circumference of the cover plate includes a plurality of inwardly facing projections adapted to cooperate with complementarily shaped formations of the rim of the wheel.

9. The luggage wheel assembly of claim 4, wherein the circumference of the cover plate includes a plurality of inwardly facing projections adapted to cooperate with complementarily shaped formations of the rim of the wheel.

10. The luggage wheel assembly of claim 5, wherein the circumference of the cover plate includes a plurality of inwardly facing projections adapted to cooperate with complementarily shaped formations of the rim of the wheel.

11. The luggage wheel assembly of claim 6, wherein the projections slidably engage said formations to absorb impact during use.

12. The luggage wheel assembly of claim 7, wherein the projections slidably engage said formations to absorb impact during use.

13. The luggage wheel assembly of claim 8, wherein the projections slidably engage said formations to absorb impact during use.

14. The luggage wheel assembly of claim 9, wherein the projections slidably engage said formations to absorb impact during use.

15. The luggage wheel assembly of claim 10, wherein the projections slidably engage said formations to absorb impact during use.

16. A luggage wheel assembly comprising a luggage wheel body having:
an axle engaged to a luggage wheel housing in use so that the luggage wheel body has an outer side facing away from the luggage wheel housing;
a luggage wheel bearing rotatably interconnecting the luggage wheel body and the axle;
a fixing plate secured to the outer side of the luggage wheel body; and
a cover plate removably secured to the fixing plate wherein the cover plate extends from a central portion of the outer side of the luggage wheel body towards a rim of the luggage wheel body.

17. The luggage wheel assembly of cl aim 16, wherein a circular fixing plate is secured axially to the outer side of the wheel by a plurality of equiangularly spaced fasteners.

18. The luggage wheel assembly of claim 16, wherein the cover plate is circular and secured by an axial fixing to the fixing plate.

19. The luggage wheel assembly of claim 16, wherein the cover plate is composed of a resilient material.

20. The luggage wheel assembly of claim 16, wherein the circumference of the cover plate includes a plurality of inwardly facing projections adapted to cooperate with complementarily shaped formations of the rim of the wheel.
